(19) United States
(12) Patent Application Publication
(10) Pub. No.: US 2010/0002714 A1
(43) Pub. Date: Jan. 7, 2010

(54) PCI express network

(76) Inventors: George Madathilparambil George, Hyderabad (IN); Susan George, Hyderabad (IN)

Correspondence Address: GEORGE MADAT-H-ILPARAMBIL GEORGE, 1208, Block 1, Naren''s SMR Vinay City, Bollaram Road, Miyapur, Hyderabad, 500049, IN

(21) Appl. No.: 12/215,727

(22) Filed: Jul. 1, 2008

(51) Int. Cl. H04L 12/56

(52) U.S. Cl. 370/402; 370/419

(57) ABSTRACT

Low communication latency, low cost and high scalability can be achieved by allowing PCI or PCI-X or PCI Express for connectivity between computers or embedded systems and network switches and for connectivity between network switches. These technologies can also be used for interconnecting storage area network switches, computers and mass-memory controllers. PCI Express root bridges in computers or embedded systems can be connected directly to network switch ports.

### BACKGROUND OF THE INVENTION

This invention relates to connecting PCI Express root bridges or PCI/PCI-X host memory bus bridges or future I/O technology host memory bus bridges in computers or embedded systems directly to network switches so that communication latency is reduced. In most of the local area networks (LANs) today Ethernet is used for interconnecting computers and switches. However, Ethernet supports much lower bandwidths compared to PCI Express and PCI or PCI-X or PCI Express transactions in computers have to be converted to Ethernet frames resulting in higher latency for communication.

U.S. patent application Ser. No. 11/242,463 shows how much higher scalability can be achieved by using PCI Express for interconnecting computers and switches in a LAN. However, U.S. patent application Ser. No. 11/242,463 claims that PCI Express end points in computers should be connected to network switches using PCI Express media. This causes higher latency and higher cost as at least two end points and two root bridges are in the path of each connection from a computer to a network switch where:
i. The first root bridge is in the computer;
ii. The first PCI Express end point is on the board in the PCI Express slot;
iii. The second PCI Express root bridge or a PCI Express end point is on the board in the PCI Express slot;
iv. The network switch port must have either a PCI Express root bridge if the board has the second PCI Express endpoint or a PCI Express end point if the board has the second PCI Express root bridge.

The U.S. patent application Ser. No. 11/505,788 shows the frame format which can be used when connecting PCI Express root bridges directly to special networks of claims of Ser. No. 11/505,788.

### BRIEF SUMMARY OF THE INVENTION

A PCI Express root bridge can be connected directly or through PCI Express switches to network switch ports which behave like PCI Express end points and can be used for transferring normal network packets. This reduces both cost and network latency as no board is needed for connectivity between the PCI Express root bridge in a computer and one or more network switch ports. Other interconnect technologies such as PCI, PCI-X or future versions of PCI or PCI-X or PCI Express can also be used for connecting host memory bridges in computers or embedded systems directly to ports in network switches.

PCI Express can be used for interconnecting network switches (both layer 2 switches (bridges) and layer 3 switches (routers)) in a LAN. In the case of such an interconnect, one of the network switch ports acts as a PCI Express end node and the other network switch port acts as a PCI Express root bridge. Similarly, PCI or PCI-X or future versions or generations of PCI or PCI-X or PCI Express can also be used for interconnecting network switches in a LAN. These technologies can also be used for interconnecting storage area network (SAN) switches, mass-memory controllers and host memory bus bridges in computers.

### BRIEF DESCRIPTION OF THE SEVERAL VIEWS OF THE DRAWINGS

FIG. 1 illustrates a network with two network switches which allow PCI Express root bridges in computers to be connected directly to network switch ports.

FIG. 2 illustrates an example of the format of a PCI Express Memory Read completion with data which can be used for forwarding a network data packet to the next hop network switch or the destination computer in response to a PCI Express Memory Read Request.

FIG. 3 illustrates an example of the format of a PCI Express Memory Read completion with data which can be used for sending two network control packets to the next hop network switch or the destination computer or the destination network switch in response to a PCI Express Memory Read Request.

FIG. 4 illustrates an example of the format of a PCI Express Memory Write Request which can be used by network switches for sending two network data packets to the next hop network switch or to the destination computer.

FIG. 5 illustrates an example of the format of a PCI Express Memory Write Request which can be used for sending a network control packet and a network data packet to the next hop network switch or the destination node.

FIG. 6 illustrates an example of the format of a PCI Express Memory Read completion with data which can be used for forwarding a Data Link frame containing a network data packet to the next hop network switch or the destination computer in response to a PCI Express Memory Read Request.

FIG. 7 illustrates an example of the format of a PCI Express Memory Read completion with data which can be used for sending two Data Link frames containing network packets to the next hop network switch or the destination node in response to a PCI Express Memory Read Request.

FIG. 8 illustrates an example of the format of a PCI Express Memory Write Request which can be used for sending a Fibre Channel frame containing a Fibre Channel data field and CRC to the next hop storage area network switch or to the destination computer or destination mass-storage controller.

FIG. 9 illustrates an example of the format of a PCI Express Memory Write Request which can be used for sending two Data Link frames containing network data packets to the next hop network switch or to the destination computer.

FIG. 10 illustrates an example of how PCI Express Memory Read transactions can be used for transmitting packets from one network switch to the next hop network switch.

FIG. 11 illustrates an example of how PCI Express Memory Write transactions can be used for transmitting packets from one network switch to the next hop network switch.

### DETAILED DESCRIPTION OF THE INVENTION

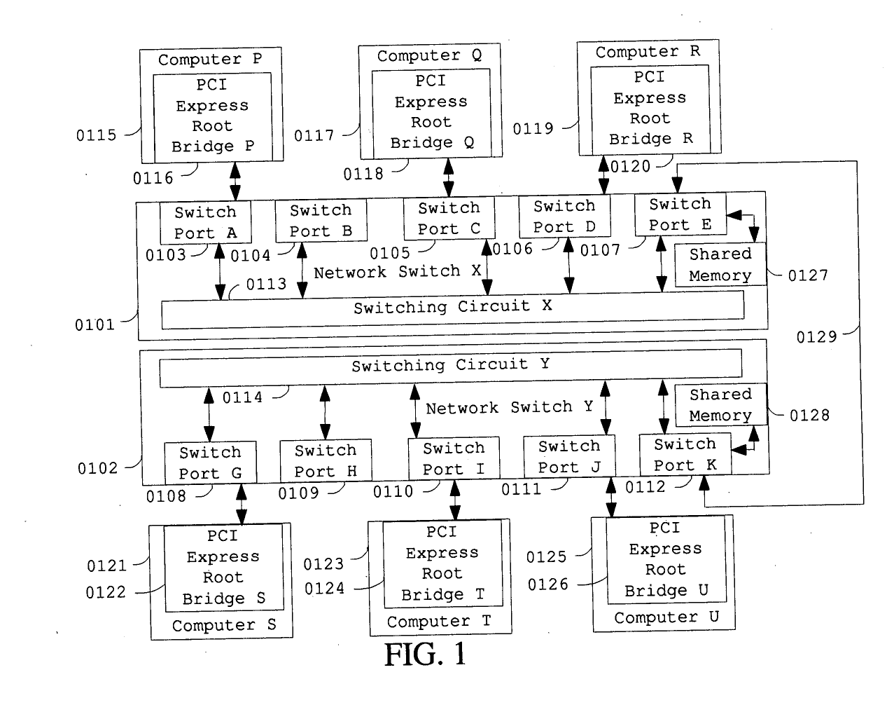

FIG. 1 illustrates a network with two network switches which allow PCI Express root bridges in computers to be connected directly to network switch ports. A network switch X 0101 has 5 switch ports, A 0103, B 0104, C 0105, D 0106 and E 0107. The switching circuit X 0113 in the network switch X 0101 interconnects these ports. A network switch Y 0102 has 5 switch ports, G 0108, H 0109, I 0110, J 0111 and K 0112. The switching circuit Y 0114 in the network switch Y 0102 interconnects these ports. The switch port E 0107 of the network switch X 0101 is connected to the switch port K 0112 of the network switch Y 0102 using a PCI Express bus 0129. The switch port E 0107 is configured to act as a PCI Express root bridge and the switch port K 0112 is configured to act as a PCI Express end point. A part of the memory 0127 in the network switch X 0101 is configured to be readable and writable by the network switch Y 0102 through the switch port E 0107 and the switch port K 0112 by the configurations in the network switches X 0101 and Y 0102. A part of memory 0128 in the network switch Y 0102 is configured to be readable and writable by the network switch X 0101 through the switch port K 0112 and the switch port E 0107 by the configurations in the network switches X 0101 and Y 0102. These memories are used for transferring (sending and receiving) network packets between network switches X 0101 and Y 0102. The PCI Express root bridge P 0116 in the computer P 0115 is connected to the switch port A 0103 in the network switch X 0101. The PCI Express root bridge Q 0118 in the computer Q 0117 is connected to the switch port C 0105 in the network switch X 0101. The PCI Express root bridge R 0120 in the computer R 0119 is connected to the switch port D 0106 in the network switch X 0101. The PCI Express root bridge S 0122 in the computer S 0121 is connected to the switch port G 0108 in the network switch Y 0102. The PCI Express root bridge T 0124 in the computer T 0123 is connected to the switch port I 0110 in the network switch Y 0102. The PCI Express root bridge U 0126 in the computer U 0125 is connected to the switch port J 0111 in the network switch Y 0102. The switch ports A 0103, C 0105, D 0106, G 0108, I 0110, and J 0111 are configured to behave like PCI Express end points.

A network switch can use a PCI Express Memory Read transaction to fetch one or more network packets from the memory in a computer or the previous hop network switch. A PCI Express Memory Read transaction consists of a PCI Express Memory Read Request and one or more PCI Express Memory Read completions. Successful PCI Express Memory Read completions will contain data. The PCI Express Memory Read Request will contain the address and the length of the network packets in the memory and PCI Express Memory Read completion data will contain the network packets. Preferably, when more than one network packet is fetched using one PCI Express Memory Read transaction, the data in the memory between the network packets, if any, must be discarded. When PCI Express Memory Read transactions are used for transmitting network packets, it is recommended that the node sending the PCI Express Memory Read Request must first fetch a set of descriptors containing the address and the length of the packets before reading the network packets using PCI Express Memory Read Requests. Since the network switch receiving the packets will be able to identify the starting location of the network packet and its length, the network switch will be able to identify the data between network packets to be discarded. The address and the length of the descriptors can be configured in the adjacent network switches/computers/embedded systems so that the descriptors can be fetched using PCI Express Memory Read transactions.

A network switch can use PCI Express Memory Write transactions to send one or more network packets to the memory in the destination computer or the destination embedded system or the destination network switch or the memory in the next hop network switch. A PCI Express Memory Write transaction consists of a PCI Express Memory Write Request.

Optionally, a device driver can use PCI Express Memory Write transactions to send one or more network packets from the memory in the source computer to the memory in the next hop network switch.

Preferably, every network switch port using PCI Express media for external connection is either configured to behave as a PCI Express end point or as a PCI Express root bridge. A network switch port can use either PCI Express write transactions and/or PCI Express Memory Read transactions for inbound network packets into the network switch. A network switch port can use either PCI Express Memory Write transactions and/or PCI Express Memory Read transactions for outbound network packets from the network switch.

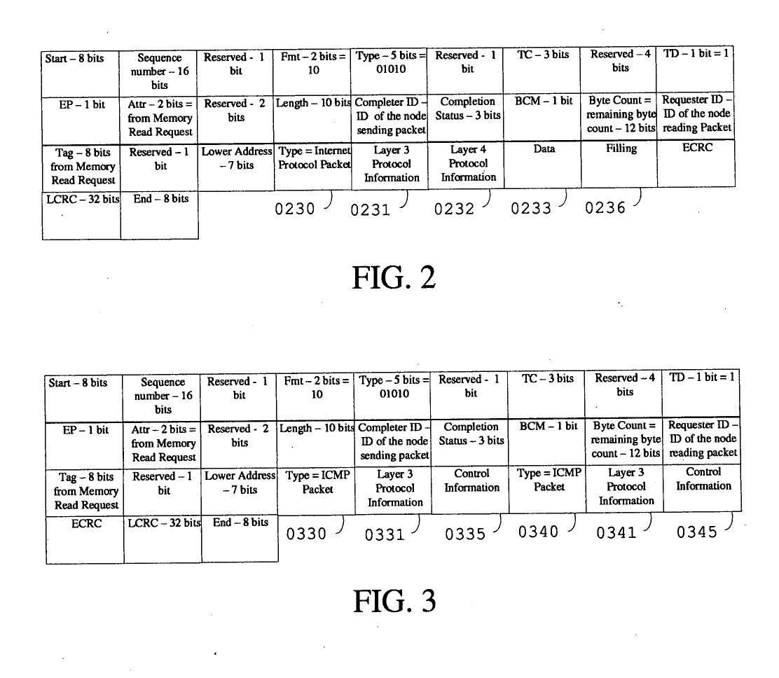

FIG. 2 illustrates an example of PCI Express Memory Read completion with data containing a network data packet. PCI Express Memory Read transactions can be used by a next hop network switch to fetch a network packet from the memory in a computer or a network switch. The type field 0230 in the PCI Express Memory Read completion data indicates that the PCI Express Memory Read completion data contains an Internet Protocol (IP) packet. The type field is a Data Link layer (layer 2) protocol information used to identify the upper layer protocol. The type field is equivalent to the destination service access point (SAP) in logical link control protocol (LLC). The layer 3 protocol information 0231 of the network packet contains an address of the destination computer which is used by the network switches to identify the next hop port. The layer 3 protocol information 0231 of the network packet also contains an address of the source computer from which the network packet originated. Layer 4 protocol information in the packet 0232 identifies the port that will receive the data in the destination computer and the source port for the data in the source computer. The network packet also contains data 0233 which gets delivered to the destination port in the destination computer. The filling 0236 is present as the PCI Express Memory Read Request requested for more data than the length of the packet. The filling can be discarded based on the length of the packet.

FIG. 3 illustrates an example of PCI Express Memory Read completion with data containing two network control packets. Examples of network control packets are ICMP packets. The type field 0330 of the first packet indicates that the packet is an Internet Control Message Protocol (ICMP) packet. The type field identifies the upper layer protocol. The layer 3 protocol information 0331 of the first network packet contains an address of the destination computer which is used by the network switches to identify the next hop port. The layer 3 protocol information 0331 of the network packet also contains the address of the source computer in which the network packet originated. The first network control packet also contains control information 0335 which gets delivered to the destination computer or the destination network switch. The type field 0340 of the second packet indicates that the packet is an Internet Control Message Protocol (ICMP) packet. The layer 3 protocol information 0341 of the second network packet contains an address of the destination computer or the network switch which is used by the network switches to identify the next hop port. The layer 3 protocol information 0341 of the network packet also contains the address of the source computer in which the network packet originated. The second network control packet contains control information 0345 which gets delivered to the destination computer or the destination network switch of the packet.

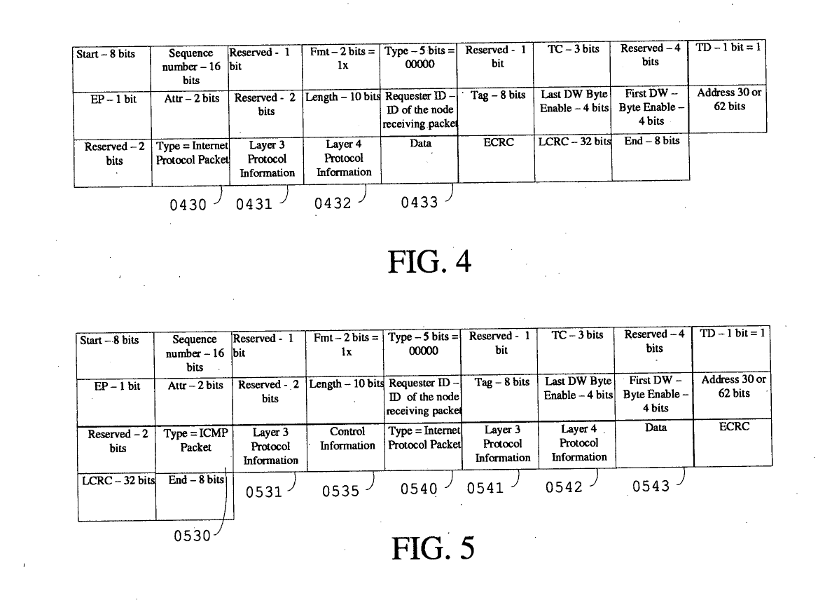

FIG. 4 illustrates an example of PCI Express Memory Write Request containing a network data packet. PCI Express Memory Write transactions can be used either by a network switch to send a network packet to the memory in the next hop network switch or to the memory in the destination computer. PCI Express Memory Write transactions can be used by a device driver in a computer to send a network packet to memory in next hop network switch. The type field 0430 in the data portion of the PCI Express Memory Write Request indicates that data in the PCI Express Memory Write Request contains an Internet Protocol (IP) packet. Layer 3 protocol information 0431 of the network packet contains an address of the destination computer which is used by the network switches to identify the next hop port. The layer 3 protocol information 0431 of the network packet also contains an address of the source computer in which the network packet originated. Layer 4 protocol information in the packet 0432 identifies the port that will receive the data in the destination computer and the source port in the source computer. The network packet also contains data 0433 which gets delivered to the destination port in the destination computer.

FIG. 5 illustrates an example of PCI Express Memory Write Request containing a network control packet and a network data packet. The type field 0530 of the first packet indicates that the packet is an Internet Control Message Protocol (ICMP) packet. The type field identifies the upper layer protocol. Layer 3 protocol information 0531 of the first network packet contains an address of the destination computer which is used by the network switches to identify the next hop port. The layer 3 protocol information 0531 of the network packet also contains an address of the source computer in which the network packet originated. The network control packet contains control information 0535 which gets delivered to the destination computer or a destination network switch. The type field 0540 of the second packet indicates that the packet is an Internet Protocol (IP) packet. The layer 3 protocol information 0541 of the second network packet contains an address of the destination computer which is used by the network switches to identify the next hop port. The layer 3 protocol information 0541 of the network packet also contains an address of the source computer in which the network packet originated. The layer 4 protocol information in the packet 0542 identifies the port that will receive the data in the destination computer and the source port in the source computer. The network packet also contains data 0543 which gets delivered to the destination port in the destination computer.

Layer 2 (Data Link layer) switching can be used by network switches connected directly to root bridges. In this case, Data Link frame containing layer 2 protocol information should be present in the PCI Express transactions so that layer 2. stack in a network switch can identify the next hop port without passing the network frame to the layer 3 stack. For example, the layer 2 protocol information can identify the destination PCI Express root bridge or the destination/intermediate network switch port to which the Data Link frame will be delivered.

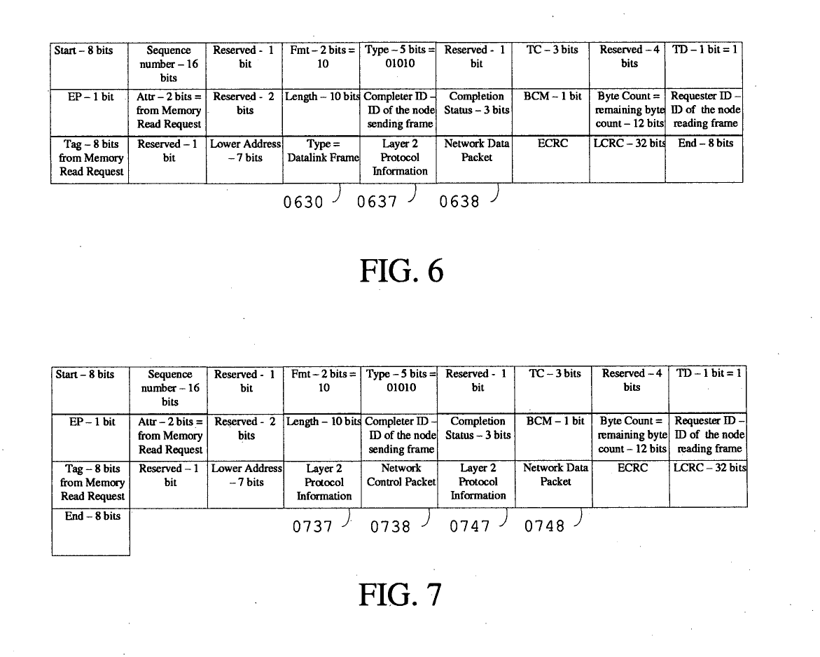

FIG. 6 illustrates an example of a PCI Express Memory Read completion with data containing a Data Link frame containing layer 2 protocol information for layer 2 switching. The type field 0630 indicates that the PCI Express Memory Read completion data contains a Data Link frame. The layer 2 protocol information 0637 contains information needed by layer 2 stack for switching and an identifier for the upper layer protocol. The layer 2 frame contains a network data packet 0638.

The type field can help in identifying the correct upper layer protocol. The type field is not required when the Data Link frame being transmitted contain information that identify the upper layer protocol and all the incoming Data Link frames have a fixed format.

FIG. 7 illustrates an example of a PCI Express Memory Read completion with data containing two Data Link frames. The layer 2 protocol information 0737 in the first Data Link frame contains information needed for layer 2 switching and an identifier which identify the upper layer protocol to which the first Data Link frame must be delivered. The first Data Link frame contains a network control packet 0738. The layer 2 protocol information 0747 in the second Data Link frame contains information needed for layer 2 switching and an identifier which identify the upper layer protocol to which the second Data Link frame must be delivered. The second Data Link frame contains a network data packet 0748.

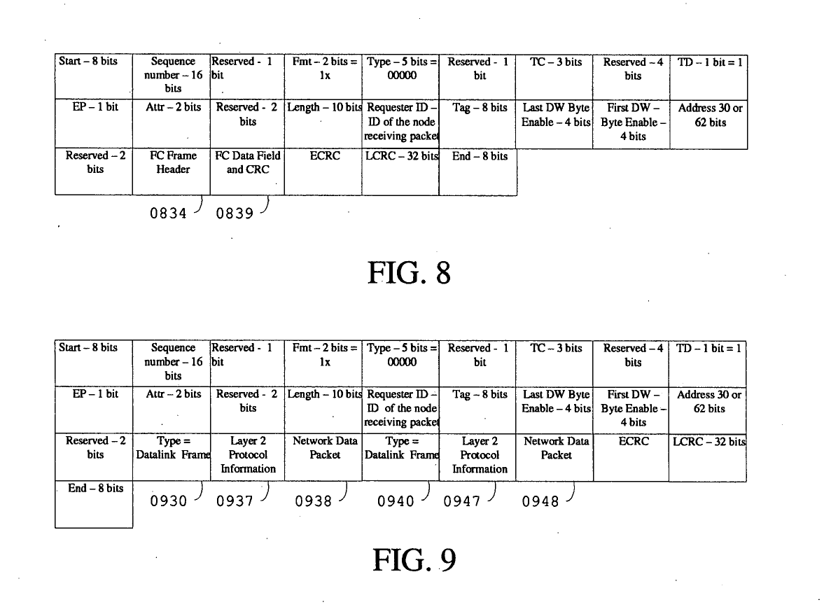

FIG. 8 illustrates an example of a PCI Express Memory Write Request containing a Fibre Channel frame. The Fibre Channel frame header 0834 contains information needed for frame switching by storage area network switches. The Fibre Channel frame contains Fibre Channel Data Field and CRC 0839.

FIG. 9 illustrates an example of a PCI Express Memory Write Request containing two Data Link frames. The type fields 0930, 0940 in the data portion of the PCI Express Memory Write Request indicates that the PCI Express Memory Write Request data contains two Data Link frames. The layer 2 protocol information 0937 of the first frame contains information needed for layer 2 switching and an identifier for the upper layer protocol. The first Data Link frame contains a network data packet 0938. The layer 2 protocol information 0947 of the second frame contains information needed by layer 2 stack for switching and an identifier for the upper layer protocol. The second Data Link frame contains a network data packet 0948.

Similarly, PCI or PCI-X host memory bus bridges can be connected to network switch ports using PCI or PCI-X media respectively where the network switch port behaves like a PCI or PCI-X device.

Similarly, future versions or generations of PCI or PCI-X or PCI Express technology host memory bus bridges can be connected to network switch ports using the corresponding future Input/Output technology physical media. These future technologies include all future versions of input/output technologies which can be used for connecting a host memory bus bridge to a peripheral device in a computer. The network switch port to which the memory bus bridge is connected behaves like a peripheral device.

Input/Output technologies such as PCI, PCI-X, PCI Express or future versions or generations of PCI or PCI-X or PCI Express can also be used for interconnecting network switches. For each such interconnect, one of the network switch ports behaves like a host memory bridge and the other network switch port behaves like a peripheral device. Preferably, both these network switch ports should allocate or allow network administrators to allocate one or more memories readable and/or writable by the network switch port or the network switch on the other side of the interconnect. These network switch ports or network switches must also configure or allow network administrators to configure one or more address ranges for those memories readable and/or writable by the network switch port or the network switch on the other side of the interconnect. These address ranges will allow the ports on either side of the interconnect to use the same address for the same shared memory location. Each network switch port may limit the maximum amount of memory that can be configured as shared memory and the maximum number of address ranges for the shared memory.

Optionally, only one network switch port on the PCI Express interconnect between network switch ports allocates or allows network administrators to allocate one or more memories readable and/or writable by the network switch port or the network switch on the other side of the interconnect. This is less optimal as PCI Express Memory Write Requests can be initiated by a network switch port only if memory on the other side of the interconnect is writable. Similarly, PCI Express Memory Read Requests can be initiated by a network switch port only if memory on the other side of the interconnect is readable.

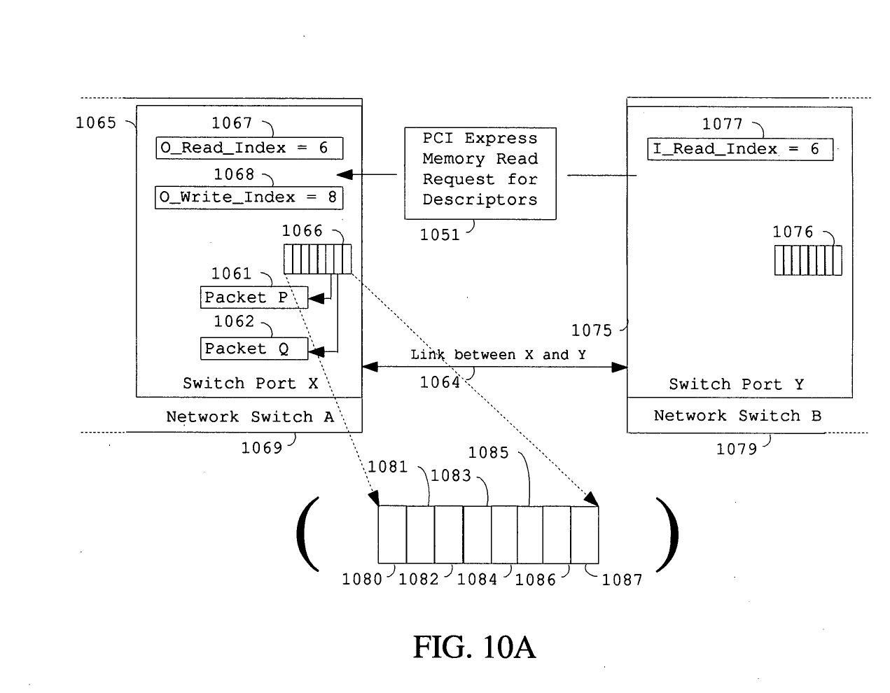

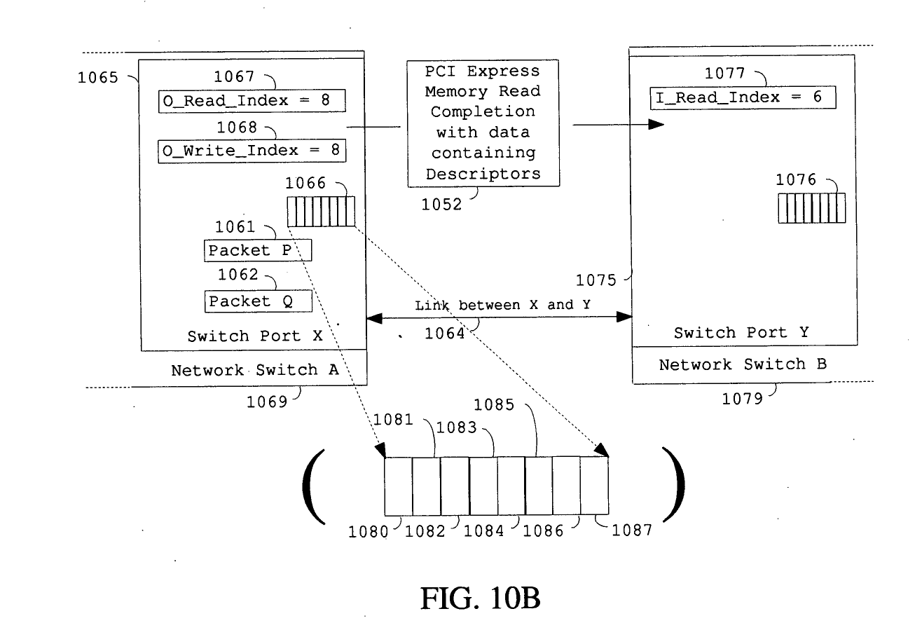

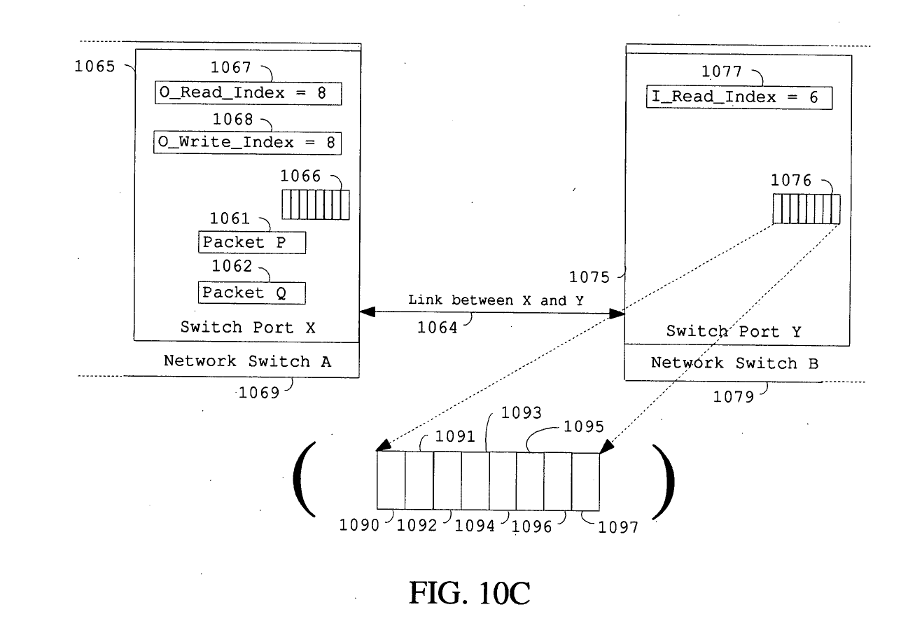

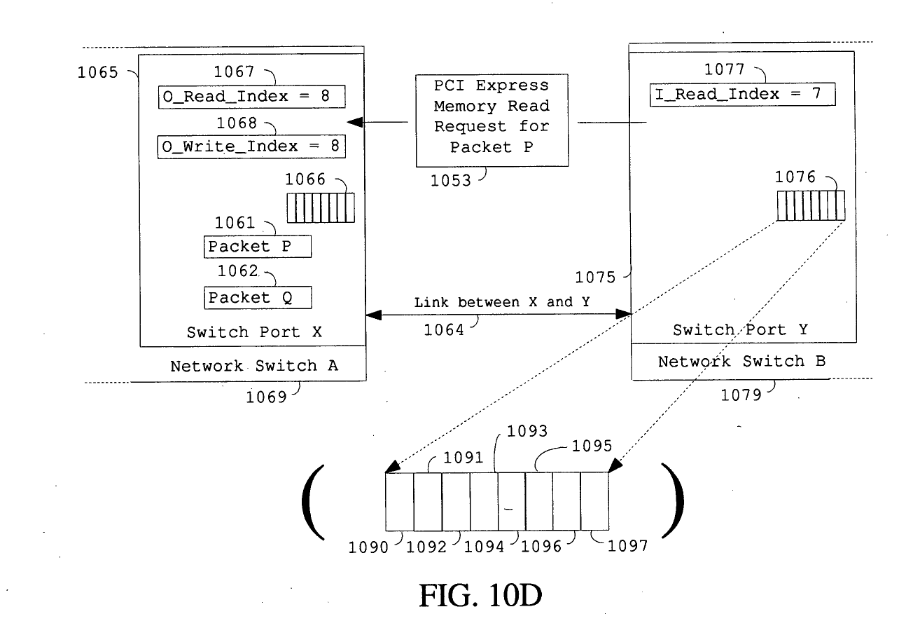

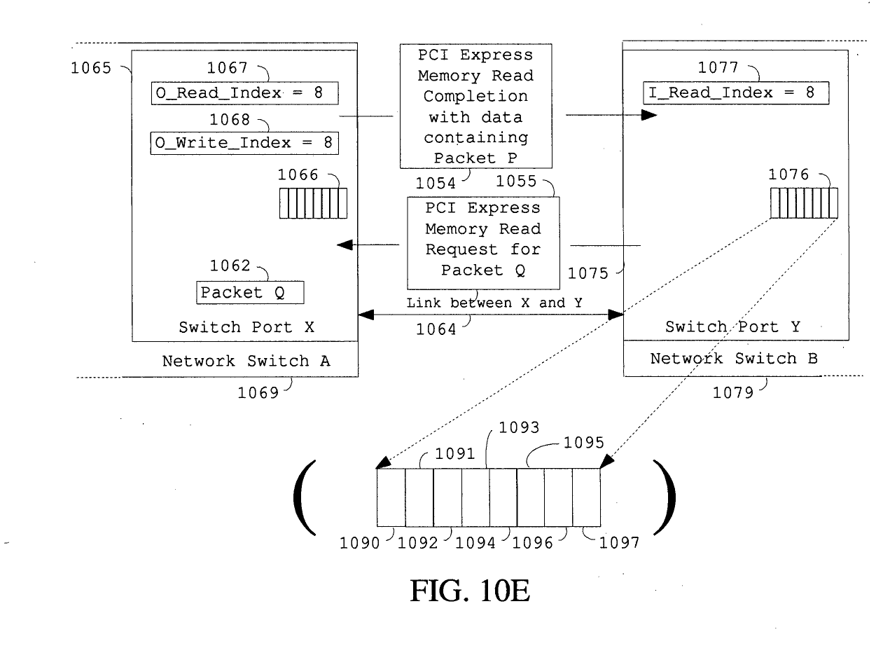

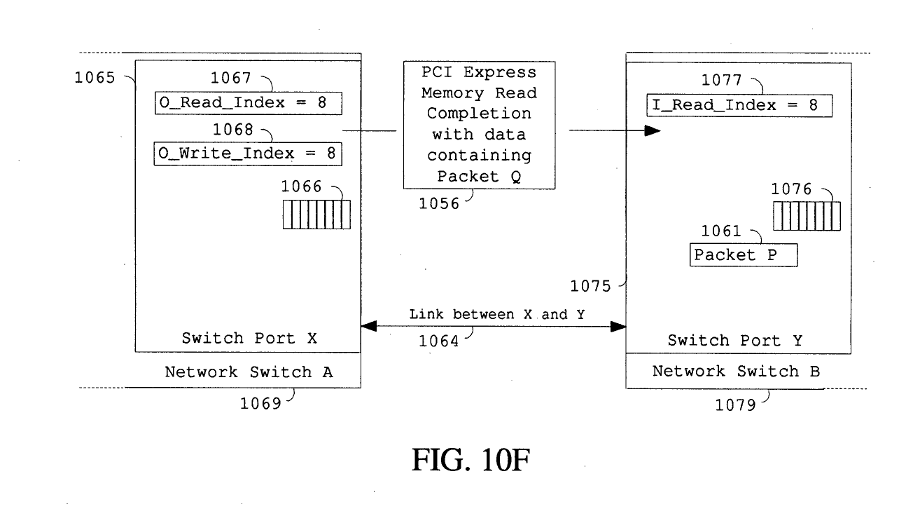

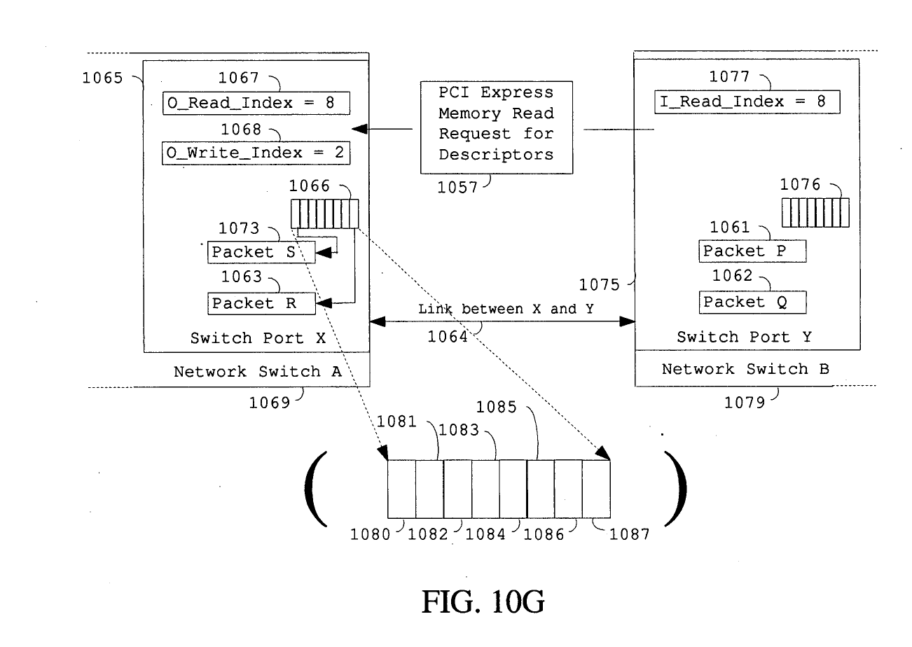

FIG. 10 illustrates an example of how PCI Express Memory Read transactions can be used for fetching network packets from an adjacent network switch or node. In the FIG. 10A, the switch port X 1065 in the network switch A 1069 contains two network packets to be transmitted to the switch port Y 1075 in the network switch B 1079 (only the portions of the network switches A and B containing the corresponding ports X and Y are shown). The descriptors in an array 1066 in the switch port X 1065 points to the packets which are to be transmitted to the switch port Y 1075. There are 8 descriptors 1080, 1081, 1082, 1083, 1084, 1085, 1086, 1087 indexed as 1 to 8. The integer variables O_Read_Index 1067 and O_Write_Index 1068 are used to create a circular buffer of descriptors. The integer variable O_Read_Index 1067 holds a value 6 and the integer variable O_Write_Index 1068 holds a value 8 indicating that the descriptor eight 1087 and the descriptors one to five 1080, 1081, 1082, 1083, 1084 are empty and that the information about the network packets which are addressed by the sixth 1085 and the seventh 1086 descriptors are not read by the switch port Y 1075. The descriptor 6 1085 contains the address and the length of the network packet P 1061. The descriptor 7 1086 contains the address and the length of the network packet Q 1062. The switch port X 1065 and the switch port Y 1075 are connected using PCI Express cable 1064. The switch port Y 1075 sends a PCI Express Memory Read Request 1051 to the switch port X 1065 containing the address and the length of the array of descriptors 1066 in the port X 1065. In FIG. 10B, the switch port X 1065 responds to the PCI Express Memory Read Request with the PCI Express Memory Read completion with data 1052 containing the descriptors, updates the contents of all the descriptors as empty and updates the integer variable O_Read_Index 1067 to the value of the integer variable O_Write_Index 1068 which is 8. The switch port X 1065 must not allow other updates to the array of descriptors 1066 or to the integer variable O_Write_Index 1068 while these operations are being done. In FIG. 10C, an array of descriptors 1076 in the switch port Y 1075 are updated with the data in the PCI Express Memory Read completion data which causes the descriptors eight 1097 and one to five 1090, 1091, 1092, 1093, 1094 to be empty, the descriptor 6 1095 to contain the address and the length of the packet P 1061 and the descriptor 7 1096 to contain the address and the length of the packet Q 1062. In FIG. 10D, the switch port Y 1075 creates a PCI Express Memory Read Request 1053 using the descriptor 6 1095 which contains the address and the length of the packet P 1061 and updates the integer variable I_Read_Index 1077 to index the next descriptor 7 1096. In FIG. 10E, the switch port X responds to the PCI Express Memory Read Request with the PCI Express Memory Read completion with data 1054 containing the packet P and the switch port Y 1075 creates a PCI Express Memory Read Request 1055 using the descriptor 7 1096 which contains the address and the length of the packet Q 1062 and updates the integer variable I_Read_Index 1077 to index the next descriptor 8 1097 which is empty. In FIG. 10F, the switch port x 1065 responds to the PCI Express Memory Read Request with the PCI Express Memory Read completion with data 1056 containing the packet Q. The packet P 1061 received by the switch port Y 1075 is passed to the upper layers of the networking stack which are identified based on the type or SAP fields in the network packet P 1061. In FIG. 10G, the packet Q 1062 received by the switch port Y 1075 is passed to the upper layers of the networking stack which are identified based on the type or SAP fields in the network packet Q 1062. Two more new packets arrive in the switch port X 1065 which are to be transmitted to the switch port Y 1075. The descriptor 8 1087 points to the first of these packets R 1063 and the descriptor 1 1080 points to the second packet S 1073 of these packets. The integer variable O_Write_Index 1068 is updated to the value 2 which points to the next empty descriptor 1081. The switch port Y 1075 sends a PCI Express Memory Read Request 1057 to the switch port X 1065 containing the address and the length of the array of descriptors 1066 in the port X 1065 which will result in the latest contents of the descriptors 1066 to be sent to the switch port Y 1075.

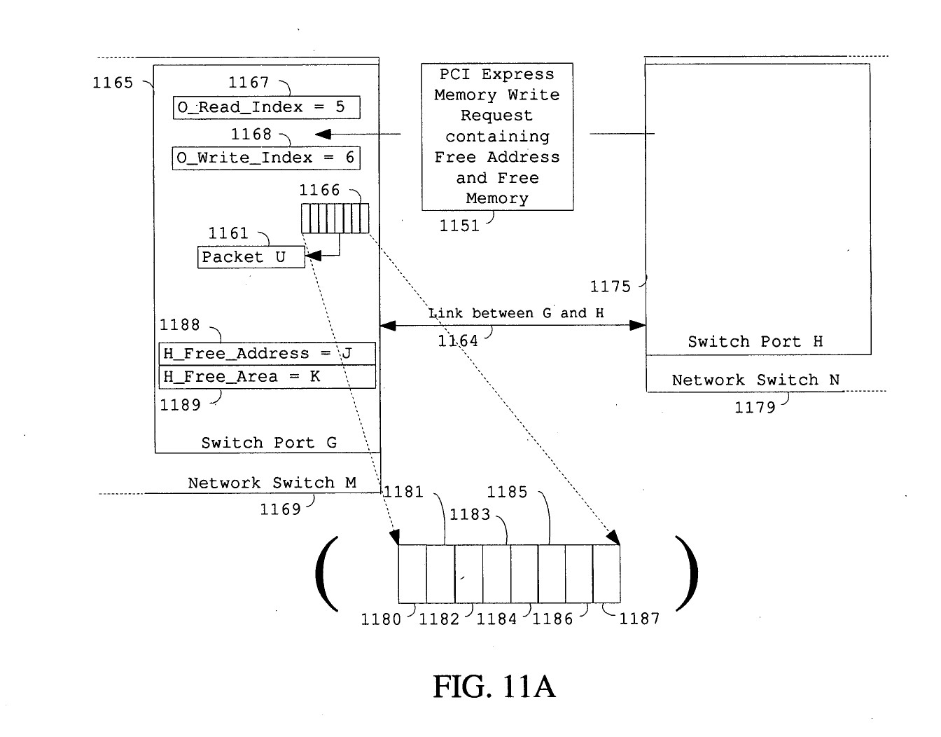

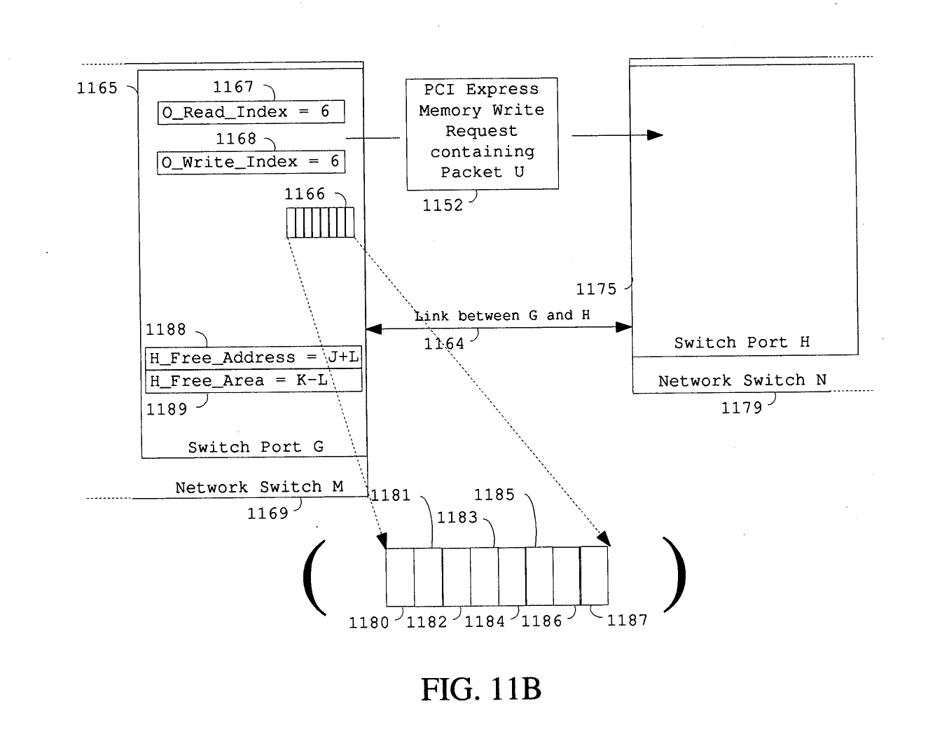

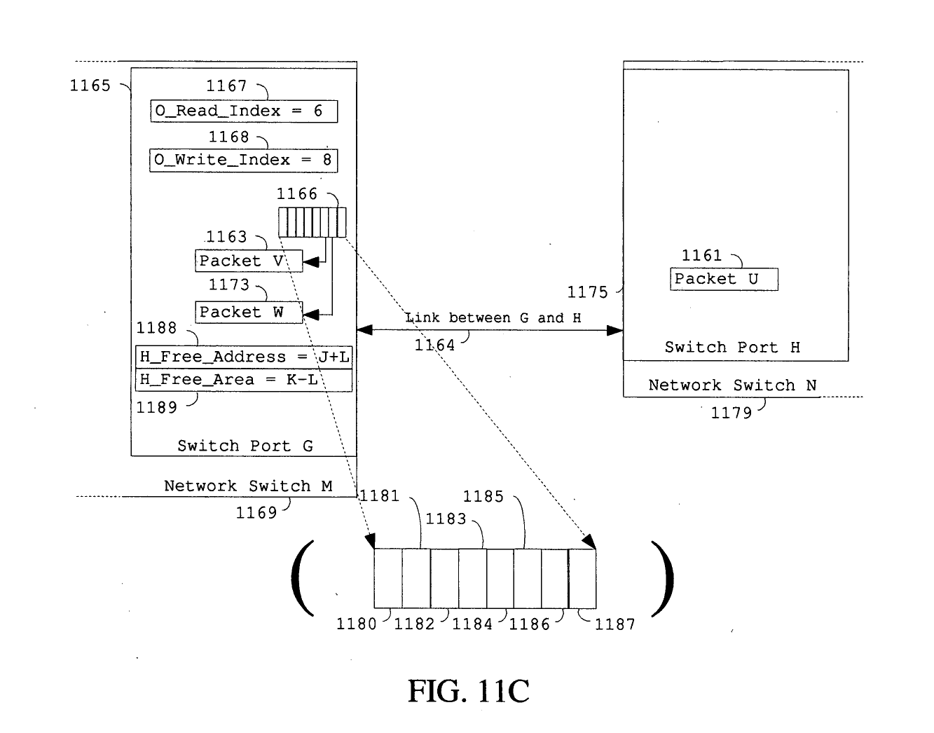

FIG. 11 illustrates an example of how PCI Express Memory Write transactions can be used for transmitting network packets from one network switch or node to the next hop network switch or node. In the FIG. 11A, the switch port G 1165 in the network switch M 1169 contains one network packet to be transmitted to the switch port H 1175 in the network switch N 1179 (only the portions of the network switches M and N containing the corresponding ports G and H are shown). The descriptors in an array 1166 in the switch port G 1165 point to the packets which are to be transmitted to the switch port H 1175. There are 8 descriptors 1180, 1181, 1182, 1183, 1184, 1185, 1186, 1187 indexed as 1 to 8 in the array 1166. The integer variables O_Read_Index 1167 and O_Write_Index 1168 are used to create a circular buffer of descriptors. The integer variable O_Read_Index 1167 holds a value 5 and the integer variable O_Write_Index 1168 holds a value 6 indicating that the descriptors six to eight 1185, 1186, 1187 and the descriptors one to four 1180, 1181, 1182, 1183 are empty and that the network packet pointed by in the fifth descriptor 1184 is not yet transmitted to the switch port H 1175. The descriptor 5 1184 contains the address and the length of the network packet U 1161. The switch port G 1165 and the switch port H 1175 are connected using PCI Express cable 1164. The switch port H 1175 uses a PCI Express Memory Write Request 1151 to overwrite the contents of variables H_Free_Address 1188 and H_Free_Area 1189. The variables H_Free_Address 1188 and H_Free_Area 1189 provide the address and available space in a buffer in the switch port H 1175. This information is used by the switch port G 1165 to create PCI Express Memory Write Requests. In FIG. 11B, the switch port G 1165 creates a PCI Express Memory Write Request 1152 using the address in the variable H_Free_Address 1188 to transmit the network packet U 1161 addressed by the descriptor 5 1184 to the switch port H 1175 and updates the integer variable O_Read_Index 1167 to index the descriptor 6 1185 which is empty. The switch port G 1165 increments the variable H_Free_Address 1188 with the length of the packet U 1161 to point to the next available free buffer location. The switch port G 1165 subtracts the length of the packet U 1161 from the variable H_Free_Area 1189 to indicate the reduced space in the buffer in the switch port H 1175. In FIG. 11C, the packet U 1161 is placed in the buffer and two more packets arrive in the switch port G 1165 which are to be transmitted to the switch port H 1175. The address of the packet U 1161 and its length are extracted from the PCI Express Memory Write Request and are passed to the upper layers of the networking stack which are identified based on the type or SAP fields in the packet U 1161. The descriptor 6 1185 points to the first of the new packets V 1163 and the descriptor 7 1186 points to the second packet W 1173 of the new packets. The integer variable O_Write_Index 1168 is updated to the value 8 which points to the next empty descriptor 1187.

PCI Express Memory Write transactions can be used to send a list of buffer addresses and buffer lengths to an adjacent port which can be used by that port to transmit network packets and Data Link frames using PCI Express Memory Write transactions. The address where the list of buffer addresses and buffer lengths must be written can be configured as part of the network switch configuration.

PCI Express Memory Write transactions are more efficient than PCI Express Memory Read transactions when network traffic is low, as reading of the descriptors and PCI Express Memory Read completions are not required. However, when the network switch needs to limit incoming traffic when the network is congested, PCI Express read transactions can become more efficient. In this case, the network switch will not send the list of buffers which can be used for PCI Express Memory Write transactions and will instead read the descriptors and fetch the corresponding network packets or Data Link frames in a way that network congestion is avoided. Preferably, each port should be able to use PCI Express Memory Write transactions or PCI Express Memory Read transactions depending on the load conditions. Preferably, when the network gets congested, the descriptors can be transmitted using PCI Express Memory Write Requests and the network packets or the Data Link frames can be transmitted using PCI Express Memory Read transactions.

Similarly, memory read transactions and memory write transactions can be used in an optimal way depending on the load conditions by network switches with the current and future versions of input/output technologies such as PCI, PCI-X and PCI Express used for network switch connectivity.

Any protocol data unit (PDU) can be transmitted using PCI Express Memory Write or PCI Express Memory Read transactions as illustrated in FIG. 10 and FIG. 11. PCI Express can be used for connecting PCI Express root bridges directly or through PCI Express switches to mass-memory (storage disk/array) controllers where mass-memory controllers behave like PCI Express end points. Similarly, PCI Express can be used for interconnecting SAN switches and/or connecting SAN switches to mass-memory controllers and/or computers. In the case where PCI Express is used for connectivity between a port in one storage area network switch and a port in another storage area network switch, one of these storage area network switch ports behaves like a PCI Express root bridge and the other storage area network switch port behaves like a PCI Express end point. The data portion of PCI Express Memory Write requests or PCI Express Memory Read completions with data can be used for communicating SCSI 3 messages, commands, status and data. The data portion of PCI Express Memory Write requests or PCI Express Memory Read completions must also contain either port location or the identifier of the initiator or the target which is needed for switching.

The current and future versions of Input/Output technologies such as PCI or PCI-X or PCI Express can also be used for interconnecting SAN switches, for connecting computers or mass-memory controllers to SAN switches and for connecting mass-memory controllers directly to host memory bus bridges. When mass-memory controllers are connected directly to host memory bus bridges, these mass-memory controllers must behave like peripheral devices.

What is claimed is:

1. A method for connecting a PCI Express root bridge to a network switch port by:
i. The network switch port behaving like a PCI Express end point;
ii. Using a PCI Express physical link for direct connectivity or for connectivity through PCI Express switches;
iii. Using PCI Express Memory Read and/or Memory Write transactions for transferring network packets and/or Data Link frames between the network switch port and the PCI Express root bridge;

2. Each network switch containing network switch ports of claim (1) using PCI Express on some or all of its ports for connectivity to computers or embedded systems or to other switches; The network switch can be a layer 2 switch (bridge) or a layer 3 switch (router) or a storage area network (SAN) switch.

3. In the case where PCI Express is used for connectivity between a port in one network switch and a port in another switch as claimed in (2), one of these network switch ports behaving like a PCI Express root bridge and the other network switch port behaving like a PCI Express end point. Preferably, the network switch port or the network switch on each side of each of the PCI Express links allocating or allowing a network administrator to allocate one or more memories which are readable and/or writable by the network switch port on the other side of the interconnect or by the network switch on the other side of the interconnect.

4. Network switches allowing direct connectivity between current and future versions or generations of PCI or PCI-X or PCI Express host memory bus bridges in computers or embedded systems or other network switches and network switch ports using the corresponding current or future versions or generations of PCI or PCI-X or PCI-Express media.

5. These future generations of technologies of claim (4) include all future versions of input/output technologies which can be used for connecting a host memory bus bridge to a peripheral device in a computer or an embedded system; The network switch port to which the host memory bus bridge in a computer or an embedded system or a network switch is connected behaving like a peripheral device.

6. Network switches allowing connectivity to other network switches using current or future versions or generations of PCI or PCI-X or PCI-Express.

7. These future technologies of claim (6) include all future versions of input/output technologies which can be used for connecting a host memory bus bridge to a peripheral device in a computer or an embedded system; One of the network switch ports on each of these interconnects behaving like host memory bridge and the other network switch port on that interconnect behaving like a peripheral device; Preferably, each network switch port on these interconnects allocating or allowing a network administrator to allocate one or more memories which are readable and/or writable by the network switch port or the network switch on the other side of the interconnect.

8. Optionally, only one network switch port on each of the interconnects of claim (7) allocating or allowing a network administrator to allocate one or more memories which are readable and/or writable by the network switch port or the network switch on the other side of the interconnect.

9. The network switches of claim (2) using PCI Express Memory Read transactions or PCI Express Memory Write transactions for transmitting network packets and/or Data Link frames depending on the configuration and network load conditions. Preferably, when the network traffic is low the network switches using PCI Express Memory Write transactions and when the network traffic is high the network switches using PCI Express Memory Read transactions.

10. The network switches of claim (4) using memory read transactions or memory write transactions for transmitting network packets and/or Data Link frames depending on the configurations and network load conditions. Preferably, when the network traffic is low the network switches using memory write transactions and when the network traffic is high the network switches using memory read transactions.

11. Using the PCI Express in Storage Area Network (SAN) switches as claimed in (2) by:
i. Using mass-memory controllers which behave either like a PCI Express end node or a PCI Express root bridge;
ii. Using the data portion of PCI Express Memory Write requests or the data portion of PCI Express Memory Read completions with data for communicating mass-memory protocol messages, commands, status and data;
iii. SAN switches using either initiator/target identifier or initiator/target port location in the data portion of PCI Express Memory Write requests or the data portion of PCI Express Memory Read completions with data for switching.

12. The mass-memory controllers which behave like PCI Express end nodes as claimed in (11) can be connected directly or through PCI Express switches to PCI Express root bridges using PCI Express physical media.

13. Using the input/output technologies of claim (5) for:
i. Interconnecting Storage Area Network (SAN) switches;
ii. Connecting host memory bus bridges in computers or mass-memory controllers to SAN switch ports;
iii. Connecting host memory bus bridges to mass-memory controllers; In the case where host memory bus bridges are connected to mass-memory controllers using these input/output technologies, the mass-memory controllers behaving like Input/Output peripheral devices.

14. Mass-memory protocol commands of claim (11) include SCSI 3 commands; Mass-memory status of claim (11) include SCSI 3 status. Mass-memory messages of claim (11) include SCSI 3 messages.
